(19) United States
(12) Patent Application Publication
(10) Pub. No.: US 2023/0173706 A1
(43) Pub. Date: Jun. 8, 2023

(54) Sawmill

(71) Applicant: Karl Peterson, Ohauiti Tauranga (NZ)

(72) Inventor: Karl Peterson, Ohauiti Tauranga (NZ)

(21) Appl. No.: 18/076,239

(22) Filed: Dec. 6, 2022

(30) Foreign Application Priority Data
Dec. 7, 2021 (AU) 2021282403

(51) Int. Cl. B27B 5/18; B27B 5/20; B27B 5/36

(52) U.S. Cl. CPC B27B 5/187; B27B 5/207; B27B 5/36

(57) ABSTRACT

A sawmill includes a saw carriage and a swing saw which in turn has a circular blade and a drive shaft. The mill also includes a pair of ground engaging tracks. The saw carriage has a pair of posts/uprights each supporting an opposite end of a cross-frame, which incorporates a clamp at each end, and these can be tightened against one of the posts to stabilise the saw carriage. The saw cantilevers from the saw carriage such that the saw's drive shaft is to one side of the cross-frame regardless of whether the blade is in a vertical or horizontal cutting orientation. The carriage moves along the tracks to carry the saw to make cuts in the longitudinal dimension of a log. The saw is also arranged to move laterally along the carriage between the uprights to make cuts the lateral dimension of the log.

### FIELD OF INVENTION

This invention relates to a sawmill, preferably for milling timber.

### BACKGROUND

It is known to use sawmills to cut flitches or slabs from wooden logs, for creating boards, beams, bench tops, panels, etc, for use in building. These may have a carriage that moves on tracks or rails to carry a swing-blade saw back and forth along the log. At a first pass the saw may make a horizontal cut in the log, and on the return pass an intersecting vertical cut. The process may be repeated over and over until a row of boards is cut from the log one after the other. The saw is then lowered and a further row of boards is cut from the log in the same way. This lowering and cutting is repeated until the log is not large enough to offer up any more boards.

Sawmills as above present a design issue in that they need to have a rigid robust construction to withstand the sort of forces at play when in use, and also to provide good access to the area around the saw. It is desirable to achieve this without having to engineer the mill to the point it becomes uneconomic or inconvenient to produce or relocate. This is particularly so when it comes to portable sawmills which need to be readily transportable from one site to the next.

### OBJECT

It is an object of preferred embodiments of the invention to go at least some way towards addressing the above problems. However, it should be appreciated that the object of the invention per se is simply to provide a usual choice, and therefore any objects or advantages applicable to any preferred embodiment should not be taken as a limitation on the scope of any claims expressed more broadly.

### Definitions

The term “comprises” or “has”, if and when used in this document in relation to one or more features, should not be seen as excluding the option of there being additional unmentioned features. The same applies to derivative terms such as “comprising” and “having”.

### SUMMARY OF THE INVENTION

A sawmill comprising:
a) a saw carriage;
b) a swing saw, the saw having a circular blade and a drive shaft for spinning the blade; and
c) tracks;
characterised in that:
d) the saw carriage has a pair of posts each supporting an opposite end of a cross-frame;
e) the cross-frame has a clamp at each end;
f) each clamp can be tightened against an associated one of the posts to stabilise the saw carriage during milling of a log;
g) the saw is cantilevered from the saw carriage such that the saw's drive shaft is to one side of the cross-frame regardless of whether the blade is in a vertical or horizontal log cutting orientation;
h) the carriage is adapted to move along the tracks to carry the saw to make cuts in the longitudinal dimension of a log; and
i) the saw is arranged to move laterally along the carriage between the posts to make cuts the lateral dimension of the log.

Optionally in each case the clamp has slides or rollers that sandwich the associated post to restrict lateral movement of carriage.

Optionally the carriage has a foot at each end which in each case engages and moves along a respective one of the tracks by way or base-slides or base-rollers.

Optionally the cross-frame comprises at least a pair of spaced horizontal beams extending between the posts and which engage the posts by way of the clamps.

Optionally each clamp comprises an elongate sleeve having an opening extending from one end to the other.

Optionally each sleeve is at least 13 cm long.

Optionally each sleeve is at least 15 cm long.

Optionally the cross-frame is substantially rectangular.

Optionally the long sides of the rectangular shape are one above the other such that cross-frame extends upwards in a substantially vertical plane.

### DRAWINGS

Some preferred embodiments of the invention will now be described by way of example and with reference to the accompanying drawings, of which—

FIG. 1 is an isometric view of a portable sawmill, including close-up extension imagery showing detail of the mill's saw carriage and saw;

FIG. 1a is a plan view of a clamp forming part of the sawmill;

FIG. 1b is a side elevation view of the clamp;

FIG. 2 is a side elevation view of part of the sawmill;

FIG. 2a illustrates how the mill's saw is cantilevered from the carriage;

FIG. 2b further illustrates how the mill's saw is cantilevered from the carriage;

FIG. 3 is an end elevation view of the sawmill;

FIG. 4 is a side elevation view of the sawmill when set up ready to mill a log;

FIG. 5 is a plan view of the arrangement in FIG. 4; and

FIG. 6 is an isometric view of a transporter for use with the sawmill.

### DETAILED DESCRIPTION

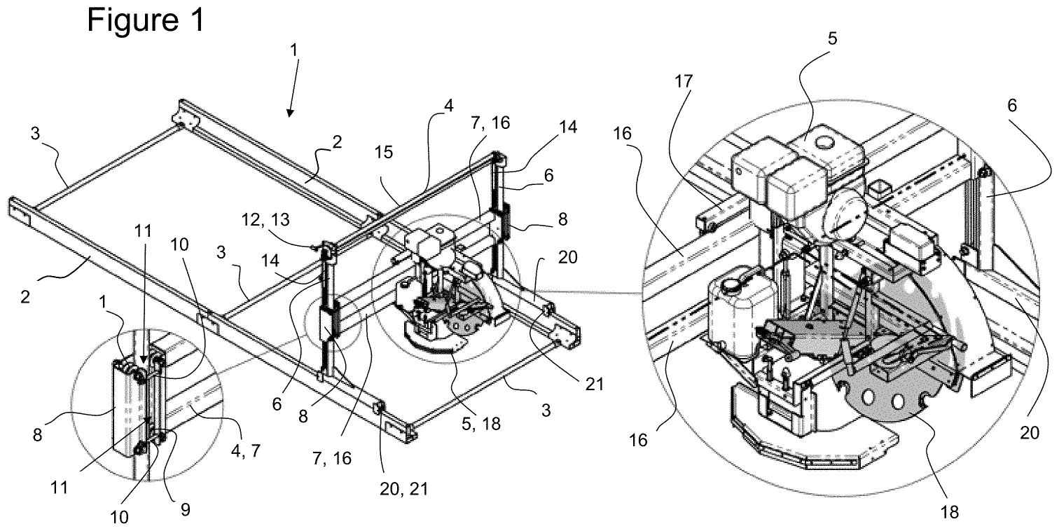

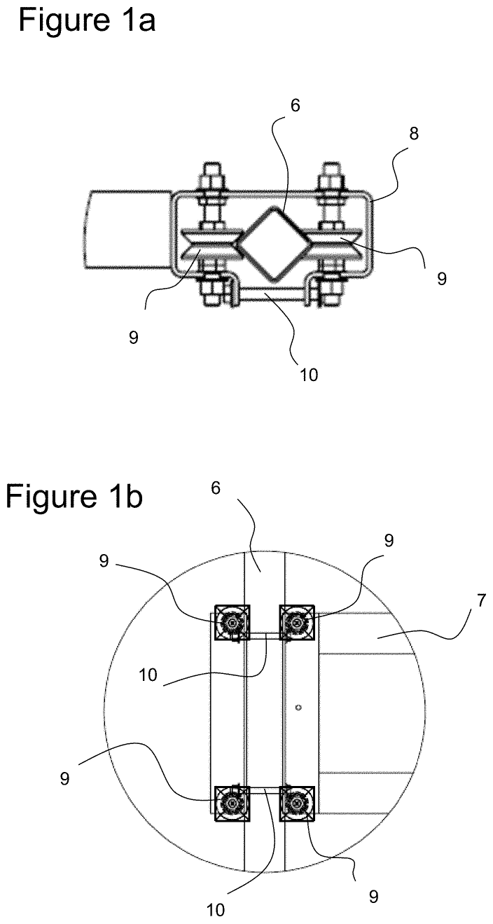

Referring to FIG. 1, the sawmill 1 has a pair of ground engaging tracks 2 arranged in parallel spaced relationship. In some embodiments, the tracks may incorporate height-adjustable feet to enable the sawmill to be levelled. The tracks are held in spaced relationship by a series of lateral bracing struts 3 arranged at about ground level.

The sawmill incorporates a saw carriage 4 that moves back and forward along the tracks to carry a swing-blade saw 5 as it goes. Swing-blades are known in the art, enabling the drive shaft and circular blade of the saw to be swung through 90° for making horizontal and then vertical cuts. The carriage has a pair of posts 6, one at each side of the mill, and a rectangular cross-frame 7. Each end of the cross-frame 7 incorporates a clamp 8 that sleeve-fits to a respective one of the posts 6. The arrangement is such that the clamps 8 can move up and down the posts 6 to enable vertical adjustment of the cross-frame 7. The clamps 8 can then be tightened against the posts 6 to resist rattle or other lateral movement of the cross-frame 7 during the milling of a log. The squeeze is preferably not so tight that the clamps are unable to move for height adjustment of the cross-frame 7.

Referring also to FIGS. 1a-1b, to assist vertical adjustment of the cross-frame 7, each clamp 8 has a pair of slides or rollers 9 at each end, so that one pair is above the other. In the case of the rollers 9 depicted, those of each pair are on opposite sides of the post. Further, each roller 9 is generally ‘V’ shaped with a pair of wider edges which sandwich part of the post 6, to help keep the roller securely engaged with it. The rollers 9 of each pair can be squeezed against the post to a greater or lesser degree depending on the level of rigidity needed in the saw carriage 4 for a particular milling job. The squeezing force is applied by moving at least one of the rollers 9 of each pair closer to the other by way of a threaded bolt 10. In this regard each clamp 8 has a vertically extending slit-like opening 11 so the clamp is generally ‘C’ shaped in transverse cross-section. When the clamp is squeezed, the opening 11 reduces, but resiliently reverts to its original size when the squeezing force is relaxed. When slides are used (eg pads or the like) instead of the rollers 9, they sandwich the posts 9 and are squeezed against them in substantially the same manner.

Referring to FIG. 1, the vertical position of the cross-frame 7 is adjustable by way of a gearbox or winch 12 set at the top of the posts. A lever 13 of the winch may be turned by hand to wind the cross-frame 7 up or down by way of cables or chains 14, and the cross-frame is then locked at the desired height. The lifting-lowering force is transferred evenly to both ends of the cross-frame 7 by way of a spinning shaft 15. Preferably the squeezing force provided by the clamps against the posts 6 is not so great that it prevents the winch from adjusting the height of the cross-frame and therefore the saw 5.

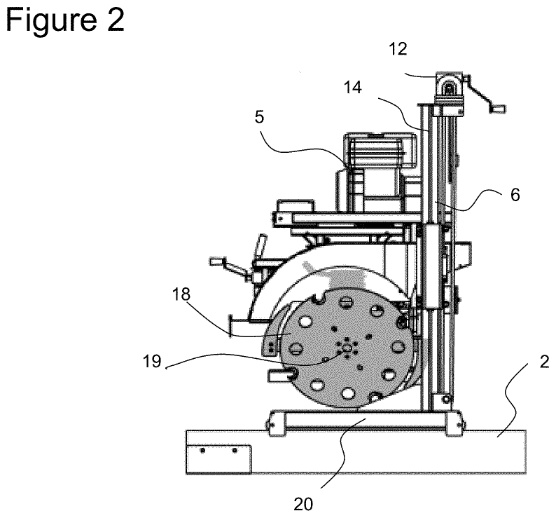

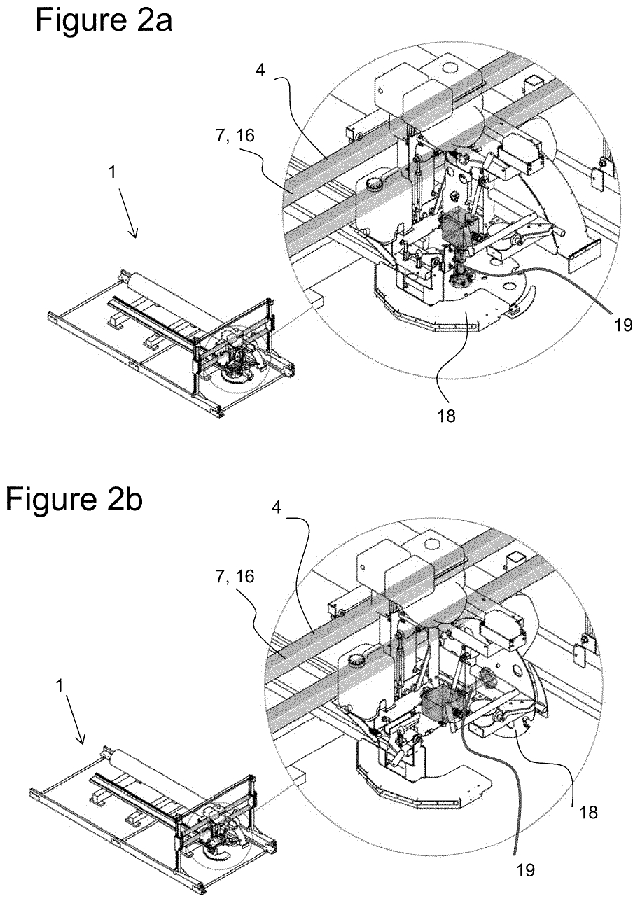

Still with FIG. 1, the cross-frame 7 is rectangular and incorporates a pair of vertically spaced horizontal beams 16, so that the cross-frame is more or less co-planar with the posts 6. The cross-frame 7 therefore sits in a vertical orientation rather than a horizontal one. The saw carriage has a sub-carriage 17 arranged to roll along at least the upper beam 16 to adjustably carry the saw 5 between the posts 6, or in other words ‘laterally’. In some embodiments of the invention the sub-carriage 17 may be integral with the saw 5, but in either case the saw 5 cantilevers at substantially one side of the saw carriage 4. The cantilever is such that the drive shaft that spins the saw's blade 18 is to the same side of the cross-frame 7 regardless of whether the blade is in a horizontal cutting position as shown in the centre image in FIG. 1, or in a vertical cutting position as shown in FIG. 2 (which indicates the axial position of the drive shaft 19—i.e. it extends back into and at right angles to the page). FIG. 2a more clearly illustrates the position of the drive shaft 19, being to one side of the saw carriage 4 when the blade 18 is in a horizontal cutting position. And likewise, FIG. 2b shows that the drive shaft 19 remains on that side of the saw carriage 4 when the blade 18 is in its vertical cutting position.

Having the saw 5 cantilevered so it is substantially at one side of the saw carriage 4 enables easy access to the saw for making adjustments or repairs to it. The cantilever also enables ready access to the area around the blade for removing boards as they are cut from the log.

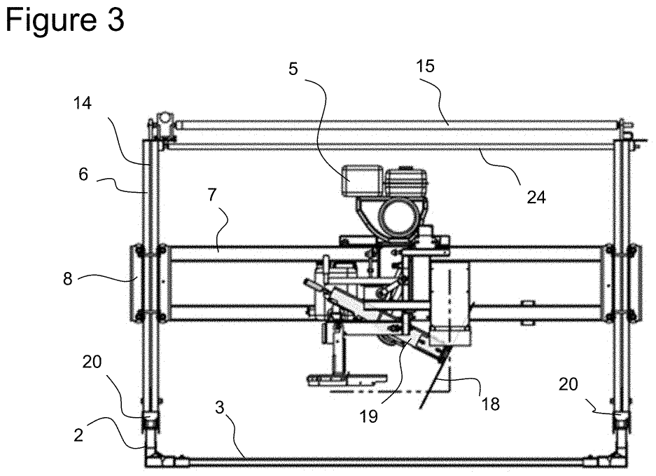

As is known in the art, the blade 18, together with its drive shaft 19, may be swung between the horizontal and vertical cutting positions, or to a setting between these, depending on the sort of cut that needs to be made. FIG. 3 indicates the blade 18 and drive shaft 19 in the process of being swung between the horizontal and vertical positions.

With particular reference to FIG. 1, but as also shown in FIGS. 2-3, the saw carriage 4 has a foot-like slider 20 at each side, arranged to run along the tracks 2 on rollers 21. The slider 20 is in each case rigidly connected to a respective one of the posts 6. When a log is positioned between and parallel to the tracks 2, the sliders 20 are moved back and forth along the tracks to carry the saw 5 in the same way. On one sweep along the log a horizontal cut is made, and on the return sweep an intersecting vertical cut is made. After each horizontal cut the saw is adjusted laterally by way of the sub-carriage 17, so that a row of boards is progressively cut from the log. The height of the cross-frame 7 is then adjusted down, and a further row of boards is cut in the same way. The process is repeated until the log is fully milled.

As shown in FIG. 3, the saw carriage 4 also incorporates a tensioner rod 24 connected to the posts 6. The rod can be caused to apply a force that urges the posts towards one another, or apart, depending on the level of adjustment employed. Preferably this is achieved by way of a screw thread engagement between the tensioner rod 24 and the posts 6. The rod acts to properly align the foot-like sliders 20 to lay parallel to the ground engaging tracks 2. More particularly, the tensioner serves to twist each post 6, which in turn twists the associated foot-like slider 20 into the line.

Preferably the cross-frame 7 is metallic and involves rigid welds between the beams 16 and the clamps 8. Similarly the base sliders 20 are rigidly welded to the posts 6.

Desirably the rollers 9 of the clamps are at least 150 cm one above the other, to most favourably resist sway or bouncing of the cross-frame and therefore the saw 5 during milling of a log.

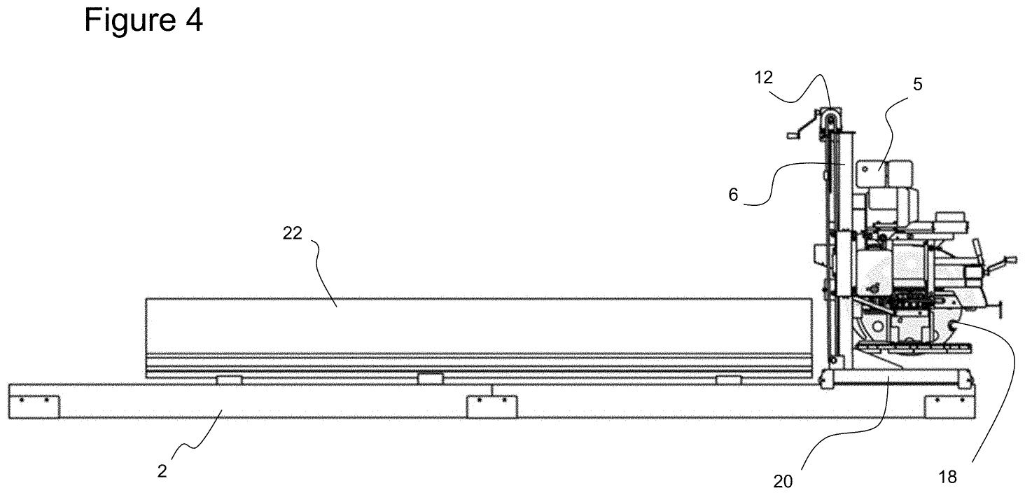

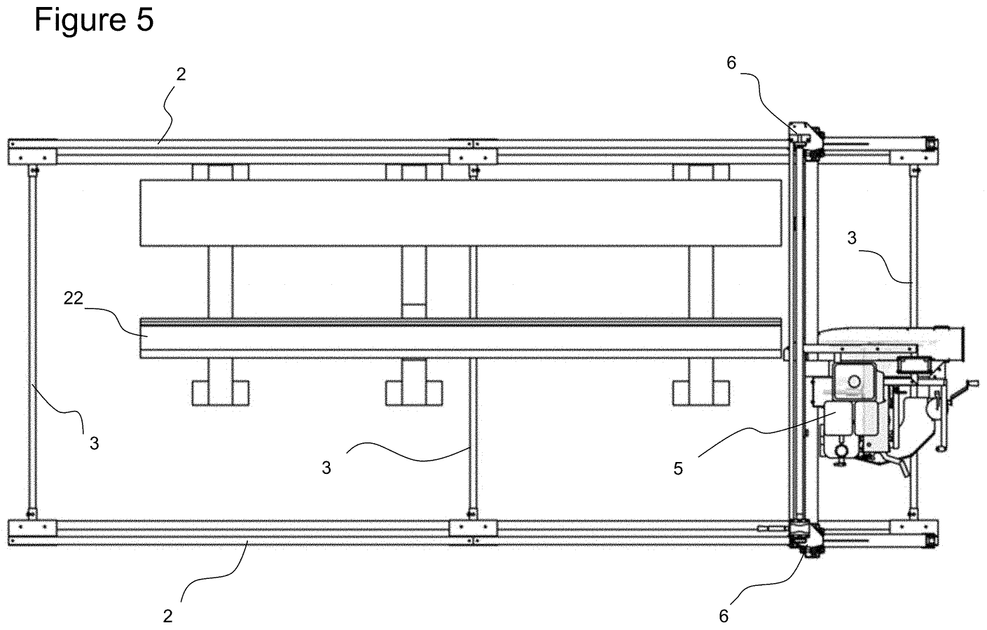

FIGS. 4-5 illustrate the sawmill 1 when it is set up with its blade 18 in a vertical cutting orientation, ready to make a cut along the length of a log 22 to be milled.

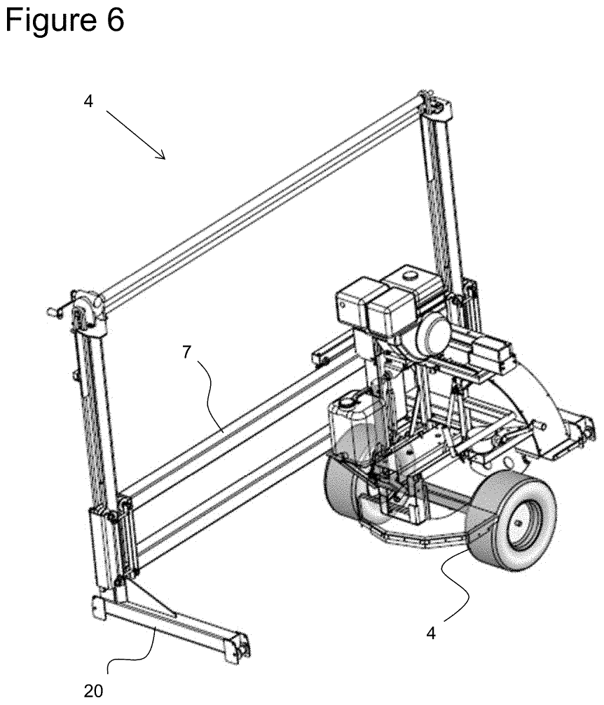

Referring to FIG. 6, to move the sawmill the saw carriage 4 is fitted to a set of wheels 23 which enables it to be rolled up to the ground tracks 2 (not shown) and lowered into place for ease of set-up.

While some forms of the invention have been described by way of example, it should be appreciated that modifications and improvements can be made without departing from the scope of the following claims.

In terms of disclosure, this document envisages and hereby posits any feature mentioned herein in combination with itself or any other feature or features mentioned herein, even if the combination is not claimed.

1. A sawmill comprising:
a) a saw carriage;
b) a swing saw, the saw having a circular blade and a drive shaft for spinning the blade; and
c) tracks;
characterised in that:
d) the saw carriage has a pair of posts each supporting an opposite end of a cross-frame;
e) the cross-frame has a clamp at each end;
f) each clamp can be tightened against an associated one of the posts to stabilise the saw carriage during milling of a log;
g) the saw is cantilevered from the saw carriage such that the saw's drive shaft is to one side of the cross-frame regardless of whether the blade is in a vertical or horizontal log cutting orientation;
h) the carriage is adapted to move along the tracks to carry the saw to make cuts in the longitudinal dimension of a log; and
i) the saw is arranged to move laterally along the carriage between the posts to make cuts the lateral dimension of the log.

2. A sawmill according to claim 1, wherein in each case the clamp has slides or rollers that sandwich the associated post to restrict lateral movement of carriage.

3. A sawmill according to claim 2, wherein the carriage has a foot at each end which in each case engages and moves along a respective one of the tracks by way or base-slides or base-rollers.

4. A sawmill according to claim 3, wherein the cross-frame comprises at least a pair of spaced horizontal beams extending between the posts and which engage the posts by way of the clamps.

5. A sawmill according to claim 4, wherein each clamp comprises an elongate sleeve having an opening extending from one end to the other.

6. A sawmill according to claim 5, wherein each sleeve is at least 13 cm long.

7. A sawmill according to claim 5, wherein each sleeve is at least 15 cm long.

8. A sawmill according to claim 5, wherein the cross-frame is substantially rectangular.

9. A sawmill according to claim 8, wherein the long sides of the rectangular shape are one above the other such that cross-frame extends upwards in a substantially vertical plane.

10. A sawmill according to claim 1, wherein the cross-frame is rectangular and comprises at least a pair of spaced horizontal beams extending one above the other between the posts and which engage the posts by way of sleeve-like clamps, each clamp being at least 13 cm long and having a slit opening extending from one end to the other, the cross-frame being such it sits in a vertical plane.

11. A sawmill according to claim 1, wherein:
a) in each case the clamp has slides or rollers that sandwich the associated post to restrict lateral movement of carriage;
b) the carriage has a foot at each end which in each case engages and moves along a respective one of the tracks by way or base-slides or base-rollers;
c) the cross-frame comprises at least a pair of spaced horizontal beams extending between the posts and which engage the posts by way of the clamps;
d) each clamp comprises an elongate sleeve having an opening extending from one end to the other;
e) the cross-frame is substantially rectangular; and
f) the long sides of the rectangular shape are one above the other such that cross-frame extends upwards in a substantially vertical plane.

12. A sawmill according to claim 11, wherein each sleeve is at least 13 cm long.

13. A sawmill according to claim 11, wherein each sleeve is at least 15 cm long.
